(19) United States
(12) Patent Application Publication
(10) Pub. No.: US 2016/0234667 A1
(43) Pub. Date: Aug. 11, 2016

(54) CALL HANDLING AND SCHEDULING BASED ON A SET OF RULES

(71) Applicant: HEWLETT PACKARD ENTERPRISE DEVELOPMENT LP, Houston, TX (US)

(72) Inventors: Adi Kidron, Yehud (IL); Erez Yaary, Yehud (IL); Nadav Greenberg, Yehud (IL); Natalie Verter, Yehud (IL)

(73) Assignee: Hewlett Packard Enterprise Development LP, Houston, TX (US)

(21) Appl. No.: 14/915,649

(22) PCT Filed: Sep. 30, 2013
(86) PCT No.: PCT/US2013/062535

§ 371 Date: Mar. 1, 2016

(51) Int. Cl. H04W 4/16; H04M 3/42; H04M 3/436

(52) U.S. Cl. CPC H04W 4/16; H04M 3/436; H04M 3/42195

(57) ABSTRACT

In an example of call handling and scheduling based on a set of rules according to aspects of the present disclosure, a method may include handling, by a receiving communications computing device, a call directed to a receiving communications device by determining whether to alert a user of the receiving communications device of the call from the calling communications device based on a set of rules. The method may also include, in response to determining not to alert the user of the receiving communications device of the call from the calling communications device, storing, by the receiving communications device, a call-back event in a call-back event queue, and scheduling, by the receiving communications device, a call-back time associated with the call-back event stored in the call-back event queue to call back the calling communications device by the receiving communications device.

### BACKGROUND

As the number of mobile devices, such as cellular telephones, tablet computers, and smartphones, have grown, so to have the number of telephone calls increased. These devices make it much easier to place and receive calls because of theft ever-present nature. Users frequently have a mobile device with them at almost all times.

### BRIEF DESCRIPTION OF THE DRAWINGS

The following detailed description references the drawings, in which:

FIG. 1 illustrates a block diagram of a computing system for call handling and scheduling based on a set of rules according to examples of the present disclosure;

FIG. 2 illustrates a block diagram of a computing device for call handling and scheduling based on a set of rules according to examples of the present disclosure; and

FIG. 3 illustrates a flow diagram of a method for call handling and scheduling based on a set of rules according to examples of the present disclosure.

### DETAILED DESCRIPTION

The following scenario is a common one in the daily routine of many people: a first person places a call to a second person, who is busy. The second person may decide to answer the call, ignore the call, send the call to voice mail, etc. Or the second person may answer the call and tell the first person that he is busy and will return the call. Similarly, the second person may ignore the call or send the call to voice mail and than send a text message to the first person saying that he is busy and will return the call.

When the second person gets around to calling the first person back, the first person may be busy, or it may not be a convenient time for the first person. This back-and-forth (sometimes referred to as “phone tag”) may go on for hours or even days. Moreover, the second person may forget to call the first person back.

Some existing scheduling systems attempt to identify free timeslots to schedule a call between the first person and the second person. However, these systems fair to handle incoming calls and reschedule them based on a set of rules.

Various embodiments will be described below by referring to several examples of call handling and scheduling based on a set of rules. The set of rules are used to determine how to handle an incoming call. If it is determined that the call should not be answered, or that a receiving user should not be alerted to the call, the call may be ignored, and the set of rules may be used to schedule a call back.

In some implementations, the call handling and scheduling based on a set of rules as described herein will help individuals manage their time more efficiently by providing call scheduling to the individuals. Call filtering will also be reduced because the individuals need not decide themselves whether to accept or reject every incoming call. Moreover, a receiving individual will know that any call coming through the system during an otherwise “busy” time is important or urgent, else the system would not have alerted the individual to the call. Additionally, the system is adaptive in providing the individuals with better control of incoming calls, which are usually unmanaged. These and other advantages will be apparent from the description that follows.

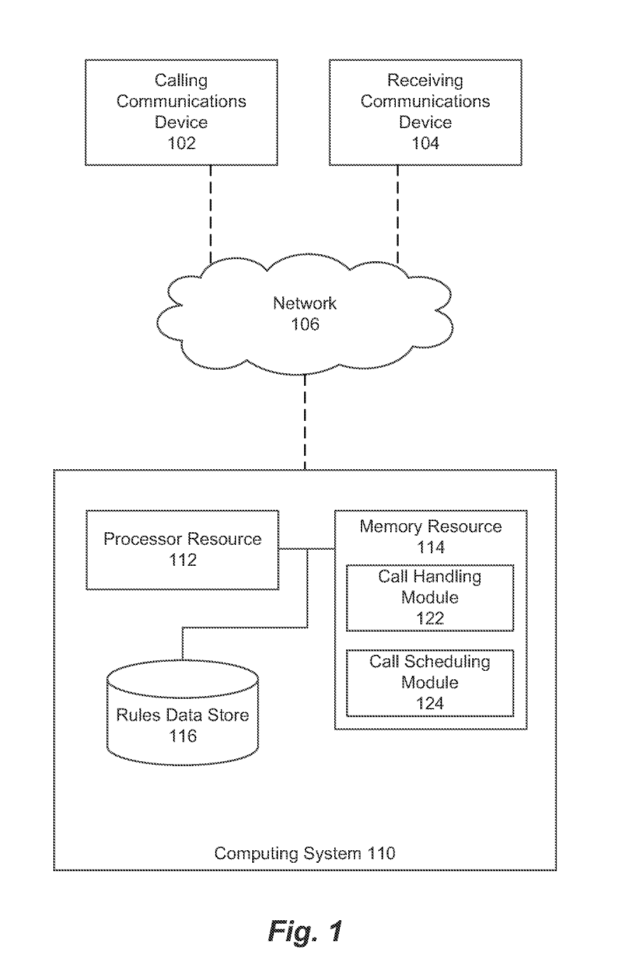

FIG. 1 illustrates a block diagram of a computing system 110 for call handling and scheduling based on a set of rules according to examples of the present disclosure. The computing system 110 may be communicatively coupled to a calling communications device 102 and a receiving communications device 104 via a network 106.

The calling communications device 102 and the receiving communications device 104 may include any appropriate type of communications device, such as a cellular telephone, smart phone, computing device equipped with communicative hardware and/or software, or any other suitable communications device. In one example, the calling communications device 102 may initiate a telephone call intended to be received by the receiving communications device 104. However, in another example, the receiving communications device 104 may initiate a telephone call intended to be received by the receiving communications device 102. Other communications devices may also be present within system 100, and may be configured to communicate with calling communications device 102 and/or receiving communications device 104.

The calling communications device 102 and the receiving communications device 104 may include a communications interface or other similar interface for a user of the device to place a telephone call and receive a telephone call. The calling communications device 102 and the receiving communications device 104 may also include a schedule of events relating to the user of the respective device.

The calling communications device 102 the receiving communications device 104 may be communicative coupled to a network 106, to which the computing system 110 is also communicatively coupled. The network 106 may be any appropriate type of electronic indications network for exchanging data between the calling communications device 102, the receiving communications device 104, and the computing system 110. For example, the network may be a cellular telephone network such as provided by a mobile telephone service carrier, may be a Wi-Fi network, and RF network, or any of the other appropriate type of wired or wireless network.

The system 100 also includes the computing system 110. It should be understood that the computing system 110 may include any appropriate type of computing device, including for example smartphones, tablets, desktops, laptops, workstations, servers, smart monitors, smart televisions, digital signage, scientific instruments, retail point of sale devices, video walls, imaging devices, peripherals, or the like.

The computing system 110 may include a processor resource 112 that may be configured to process instructions. The instructions may be stored on a non-transitory tangible computer-readable storage medium, such as memory resource 114, or on a separate device (not shown), or on any other type of volatile or non-volatile memory that stores instructions to cause a programmable processor to perform the techniques described herein. Alternatively or additionally, the computing system 110 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory. The processors and/or memories may be integrated in a single device and/or distributed across devices.

The computing system 110 may also include a rules data store 116 for storing a net of rules relating to the receiving communications device 106. The set of rules may be preconfigured or predetermined and stored in the rules data store 106 in one example, or the set of rules may be generated and stored in the rules data store 106 in another example.

The computing system 110 may further include various instructions in the form of modules stored in the memory resource 114 and executing on the processor resource 112. These modules may include a call handling module 122 and a call scheduling module 124. In one example, the modules described herein may be a combination of hardware and programming. The programming may be processor executable instructions stored on a tangible memory resource such as memory resource 114, and the hardware may include processing resource 112 for executing those instructions. Thus memory resource 114 can be said to store program instructions that when executed by the processing resource 112 implement the modules described herein. Other modules may also be utilized as will be discussed further below in other examples.

The call handling module 122 determines whether to alert a user of the receiving communications device 104 when a call is received from the calling communications device 102 based on a set of rules, such as the set of rules stored in the rules data store 116. In one example the set of rules may include a schedule determined by a user of the receiving communications device 104. In this example the user may set times when he is busy, for example, during calendar meetings having a high priority, during a meal timeslot, when he is in proximity to another person (as detected by the presence of the other person's communications device), etc. The user of the receiving communications device 104 may also set times when he is available, such as when he is in a car (identified by combination of the receiving communications device 104 being connected to the car's audio system, movement detected by the GPS of the receiving communications device 104, etc.), when he is at work and his calendar is free, and any other time which is not explicitly identified as busy. MN A user of the calling to indications device 102, or other users of the computing system 110, may similarly designate times or periods of availability and unavailability. The set of rules may also be determined by the computing device 110 based on the behavior of the users of the calling to indications device wanted to and the receiving communications device 104, as will be understood in the examples below.

When a user of the calling communications device 102 places a telephone call to a user of the receiving indications device 104, the call handling module 122 determines whether to alert the user of the receiving communications device 104 of the telephone call from the user of the calling communications device 102. For example, if the call handling module 122 determines that the user of the receiving communications device 104 is busy, based on the set of rules, the call handling module 122 will not alert the user of the receiving communications device 104 of the incoming telephone call. However, if the call handling module 122 determines that the user of the receiving communications device 104 is available, based on the set of rules, the call handling module 122 may alert the user of the receiving communications device 104 of the incoming telephone call.

In one example, the user of the calling communications device 102 may be alerted that the user of the receiving communications device 104 is unavailable when the attempts to place the telephone call to the user of the receiving communications device 104. In this example, the call handling module 122 may offer to initiate the telephone call wants the user of the receiving communications device 104 is available. Additionally, a notification may be sent to the calling communications device 102 indicating that the user of the receiving communications device 104 is unavailable.

When the call handling module 122 determines that the user of the receiving communications device 104 is unavailable, the call handling module may store a callback event in a callback event queue, or may otherwise maintain a list of “missed” calls. In this case, the user of the receiving communications device 104 may view the missed calls and/or the callback event queue.

The call scheduling module 124 is responsible for scheduling a call-back time associated with the call-back is a stored in the call-back event queue to call back the calling communications device 102 by the receiving indications device 104. The call-back may occur at a mutually available time for the users of the calling communications device 102 and receiving communications device 104. For example the call scheduling module 124 may determine and next available time for each of the respective users and schedule a callback event to occur at that time. In one example the call may be initiated by the receiving communications device 104 or the calling communications device 102 automatically, or in another example, a user of one of the devices may initiate the call-back.

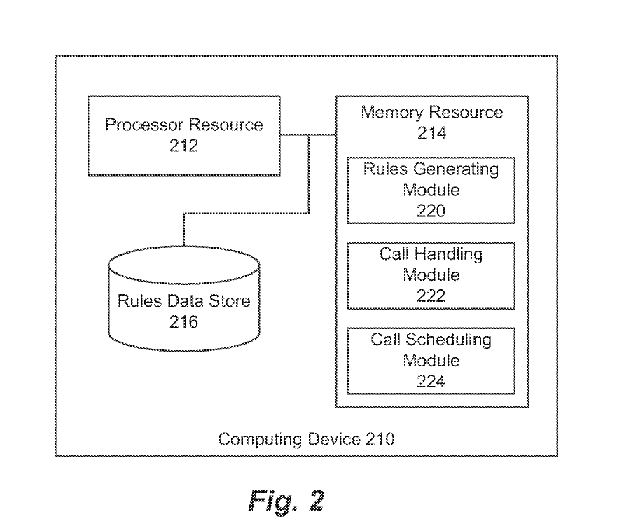

FIG. 2 illustrates a block diagram of a computing device 210 for call handling and scheduling based on a set of rules according to examples of the present disclosure. It should be understood that the computing device 210 may include any appropriate type of computing device, including for example smartphones, tablets, desktops, laptops, workstations, servers, smart monitors, smart televisions, digital signage, scientific instruments, retail point of sale devices, video walls, imaging devices, peripherals, or the like.

The computing device 210 may include a processor resource 212 that may be configured to process instructions. The instructions may be stored on a non-transitory tangible computer-readable storage medium, such as memory resource device 214, or on a separate device (not shown), or on any other type of volatile or non-volatile memory that stores instructions to cause a programmable processor to perform the techniques described herein. Alternatively or additionally, the computing device 210 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory. The processors and/or memories may be integrated in a single device and/or distributed across devices.

The computing device 210 may also include a rules data store 216 for storing a set of rules relating to the receiving communications device 206. The set of rules may be preconfigured or predetermined and stored in the rules data store 206 in one example, or the set of rules may be generated and stored in the rules data store 206, such as by a rules generating module, in another example.

The computing device 210 may further include various instructions in the form of modules stored in the memory resource 214 and executing on the processor resource 212. These modules may include a rules generating module 220, a call handling module 222, and a call scheduling module 224. In one example, the modules described herein may be a combination of hardware and programming. The programming may be processor executable instructions stored on a tangible memory resource such as memory resource 214, and the hardware may include processing resource 212 for executing those instructions. Thus memory resource 214 can be said to store program instructions that when executed by the processing resource 212 implement the modules described herein. Other modules may also be utilized as will be discussed further below in other examples.

The rules generating module 220 generates a set of rules used to determine whether to alert the user of a receiving indications device of a call from a calling communications device. The set of rules may be input by the respective users of the calling communications device and the receiving communications device in one example. However, in another example, the set of rules may be learned by the rules generating module 220 based on the behavior, schedules, movements, habits, and other data relating to the respective users. For example, the rules generating module 220 may learn a user schedule based on a schedule input by the user and the movements/behaviors of the user. The rules generating module 220 may learn that a user typically commutes to work during a certain timeslot, and that the user is available during that timeslot for receiving calls. Similarly, the rules generating module 220 may learn that a user typically ignores incoming calls during a certain timeslot in the evening, for example when the user is eating dinner or spending time with his family. Based on this learning, the rules generating module 220 may create a rule that a user should not be alerted to a call during the unavailable times observed by the rules generating module 220.

Moreover, the rules generating module may adapt the set of rules based on the user's behavior during both available and unavailable times. For example, if the user typically answers a call from a certain caller during a time otherwise identified as unavailable, the rules generating module 220 may create a rule to always alert the user of calls from that certain caller.

Similarly, if the rules generating module 220 detects that the user typically ignores calls during a certain time or event, such as within proximity of a particular other device (e.g., the user's boss's device, or the user's wife's device), the rules generating module 220 may create a rule to ignore calls when within the proximity.

The call handling module 222 determines whether to alert a user of the receiving communications device 204 when a call is received from the calling communications device 202 based on a set of rules, such as the set of rules stored in the rules data store 216. In one example the set of rules may include a schedule determined by a user of the receiving communications device 204. In this example the user may set times when he is busy, for example, during calendar meetings having a high priority, during a meal timeslot, when he is in proximity to another person (as detected by the presence of the other person's communications device), etc. The user of the receiving communications device 104 may also set times when he is available, such as when he is in a car (identified by combination of the receiving communications device 204 being connected to the car's audio system, movement detected by the GPS of the receiving communications device 204, etc.), when he is at work and his calendar is free, and any other time which is not explicitly identified as busy.

In one example, the user may easily transition his device between available in unavailable. For example, the user may use a voice command, a special device movement, proximity detection of other devices, calendar events, geo-location, indoor location, and specific time frames during the day, to indicate his availability or unavailability.

A user of the calling to indications device 202, or other users of the system 200, may similarly designate times or periods of availability and unavailability. The set of rules may also be determined by the computing device 210 based on the behavior of the users of the calling to indications device wanted to and the receiving communications device 204, as will be understood in the examples below.

When a user of the calling communications device 202 places a telephone call to a user of the receiving indications device 204, the call handling module 222 determines whether to alert the user of the receiving communications device 204 of the telephone call from the user of the calling communications device 202. For example, if the call handling module 222 determines that the user of the receiving communications device 104 is busy, based on the set of rules, the call handling module 222 will not alert the user of the receiving communications device 204 of the incoming telephone call. However, if the call handling module 222 determines that the user of the receiving communications device 204 is available, based on the set of rules, the call handling module 222 may alert the user of the receiving communications device 204 of the incoming telephone call.

In one example, the user of the calling communications device 202 may be alerted that the user of the receiving communications device 204 is unavailable when the attempts to place the telephone call to the user of the receiving communications device 204. In this example, the call handling module 222 may offer to initiate the telephone call wants the user of the receiving communications device 204 is available. Additionally, a notification may be sent to the calling communications device 202 indicating that the user of the receiving communications device 204 is unavailable.

When the call handling module 222 determines that the user of the receiving communications device 204 is unavailable, the call handling module may store a call-back event in a callback event queue, or may otherwise maintain a list of “missed” calls. In this case, the user of the receiving communications device 204 may view the missed calls and/or the callback event queue. The user may also set priorities for the call-back calls in the call-back event queue.

The call scheduling module 224 is responsible for scheduling a call-back time associated with the call-back is a stored in the call-back event queue to call back the calling communications device 202 by the receiving indications device 204. The call-back may occur at a mutually available time for the users of the calling communications device 202 and receiving communications device 204. For example the call scheduling module 224 may determine a next available time for each of the respective users and schedule a callback event to occur at that time. In one example the call may be initiated by the receiving communications device 204 or the calling communications device 202 automatically, or in another example, a user of one of the devices may initiate the call-back.

Additionally, the call scheduling module 224 may enable the user to classify calls based on importance, duration, or other factors. In such cases, the user's device can calculate expected free time (such as the time during the user's typical commute) and arrange call-back calls accordingly. For example, if the user has a 30 minute available timeslot. The call scheduling module 224 may schedule several shorter calls while saving longer calls for another available timeslot. Conversely, if a call back is flagged as important, it may receive priority above other calls regardless of duration.

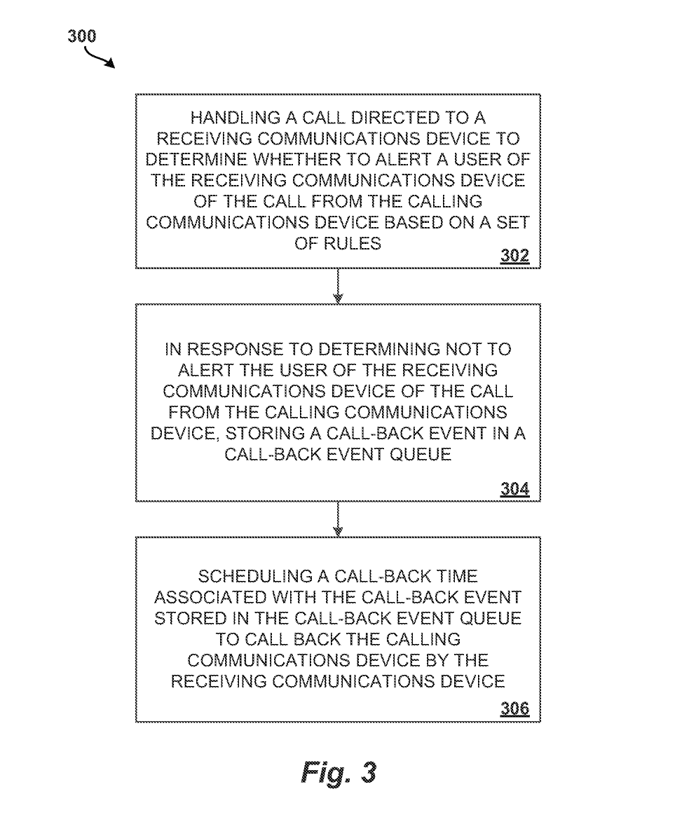

FIG. 3 illustrates a flow diagram of a method 300 for call handling and scheduling based on a set of rules according to examples of the present disclosure. The method 300 may be performed, for example, by the computing device 110 of the system 100 of FIG. 1, by the computing device 100 of FIG. 2, or by any other appropriate device. The method 300 may include the following: handling, by the communications computing device, the call by determining whether to alert a user of the receiving communications device of the call from the calling communications device based on a set of rules (block 302); in response to determining not to alert the user of the receiving communications device of the call from the calling communications device, storing, by the receiving communications device, a call-back event in a call-back event queue (block 304); and scheduling, by the receiving communications device, a call-back time associated with the call-back event stored in the call-back event queue to call back the calling communications device by the receiving communications device (block 306).

At block 302, the method 300 may include handing, by a receiving communications computing device, a call directed to a receiving communications device by determining whether to alert a user of the receiving communications device of the call from the calling communications device based on a set of rules. In one example the set of rules may relate to the receiving communications device. For example, the set of rules may include a schedule determined by a user of the receiving communications device. In this example the user may set times when he is busy, for example, during calendar meetings having a high priority, during a meal timeslot, when he is in proximity to another person (as detected by the presence of the other person's communications device), etc. The user of the receiving communications device may also set times when he is available, such as when he is in a car (identified by combination of the receiving communications device being connected to the car's audio system, movement detected by the GPS of the receiving communications device, etc.), when he is at work and his calendar is free, and any other time which is not explicitly identified as busy.

In one example, the user may easily transition his device between available in unavailable. For example, the user may use a voice command, a special device movement, proximity detection of other devices, calendar events, geo-location, indoor location, and specific time frames during the day, to indicate his availability or unavailability.

In one example, if it is determined that the user of the receiving communications device is busy or unavailable, based on the set of rules, the user may not be alerted of the incoming telephone call. However, if it is determined that the user of the receiving communications device is available, based on the set of rules, the user may be alerted alert of the incoming telephone call.

In one example, the user of the calling communications device may be alerted that the user of the receiving communications device is unavailable when the attempts to place the telephone call to the user of the receiving communications device. Additionally, a notification may be sent to the calling communications device indicating that the user of the receiving communications device is unavailable. The method 300 may continue to block 304.

At block 304, the method 300 may include in response to determining not to alert the user of the receiving communications device of the call from the calling communications device, storing, by the receiving communications device, a call-back event in a call-back event queue. When it is determined that the user of the receiving communications device is unavailable, a call-back event may be stored in a call-back event queue, or may otherwise maintain a list of “missed” calls. In this case, the user of the receiving communications device may view the missed calls and/or the call-back event queue. The user may also set priorities for the call-back calls in the call-back event queue. The method 300 may continue to block 306.

At block 306, the method 300 may include scheduling, by the receiving communications device, a call-back time associated with the call-back event stored in the call-back event queue to call back the calling communications device by the receiving communications device. The call-back may occur at a mutually available time for the users of the calling communications device and receiving communications device. For example the call scheduling module may determine a next available time for each of the respective users and schedule a callback event to occur at that time. In one example the call may be initiated by the receiving communications device or the calling communications device automatically, or in another example, a user of one of the devices may initiate the call-back.

Additional processes also may be included. For example, generating, by a rules engine, the set of rules based on historical usage data of the receiving communications device. The rules engine is stored in a memory and executing on a processor of a remote computing device communicatively coupled to he receiving communications device and the calling communications device.

It should be understood that the processes depicted in FIG. 3 represent illustrations, and that other processes may be added or existing processes may be removed, modified, or rearranged without departing from the scope and spirit of the present disclosure.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A method comprising:
handling, by a receiving communications computing device, a call directed to a receiving communications device by determining whether to alert a user of the receiving communications device of the call from the calling communications device based on a set of rules;
in response to determining not to alert the user of the receiving communications device of the call from the calling communications device, storing, by the receiving communications device, a call-back event in a call-back event queue; and
scheduling, by the receiving communications device, a call-back time associated with the call-back event stored in the call-back event queue to call back the calling communications device by the receiving communications device.

2. The method of claim 1, wherein the call-back time associated with the call-back event is a mutually available time for a user of the calling communications device and a user of the receiving communications device.

3. The method of claim 1, further comprising:
generating, by a rules engine, the set of rules based on historical usage data of the receiving communications device.

4. The method of claim 3, wherein the rules engine is stored in a memory and executing on a processor of a remote computing device communicatively coupled to the receiving communications device and the calling communications device.

5. The method of claim 1, wherein the set of rules is based in part on a first schedule of events for the receiving communications device.

6. The method of claim 1, wherein handling the call by determining whether to alert the user of the receiving communications device of the call from the calling communications device is determined in part by the availability of the user of the receiving communications device.

7. A non-transitory computer readable medium storing instructions executable by a processor, the instructions comprising:
a rules generating module to, when executed, generate a set of rules based on historical usage data of a receiving communications device and to store the generated set of rules in a rules data store;
a call handling module to, when executed, determine whether to alert a user of the receiving communications device of a telephone call from a calling communications device based on the set of rules relating to the receiving communications device stored in the rules data store; and
a call scheduling module to, when executed, schedule a call-back call when the call handling module determines not to cause the receiving communications device to alert the user of the receiving communications device of the telephone call from the calling communications device.

8. The computing device of claim 7, wherein the call-back call is stored in a call-back event queue and is a mutually available time for a user of the calling communications device and a user of the receiving communications device.

9. The computing device of claim 8, wherein the call scheduling module enables the user of the receiving communications device to assign a priority to call-back call stored in the event queue.

10. The computing device of claim 7, wherein the set of rules is based in part on a first schedule of events for the receiving communications device.

11. The computing device of claim 7, wherein determining whether to alert the user of the receiving communications device of a telephone call from a calling communications device based is determined in part by the availability of the user of the receiving communications device.

12. A system comprising:
a processor;
a memory;
a rules data store for storing a set of rules relating to a receiving communications device stored therein.
a call handling module stored in the memory and executable by the processor to determine whether to alert a user of the receiving communications device of a telephone call from a calling communications device based on the set of rules relating to the receiving communications device stored in the rules data store; and
a call scheduling module stored in the memory and executable by the processor to schedule a call-back call when the call handling module determines not to alert the user of the receiving communications device of the telephone call from the calling communications device.

13. The system of claim 12, further comprising:
a rules generating module stored in the memory and executable by the processor to generate a set of rules based on historical usage data of a receiving communications device and to store the generated set of rules in the rules data store.

14. The system of claim 12, wherein determining whether to alert the user of the receiving communications device of a telephone call from a calling communications device based is determined in part by the availability of the user of the receiving communications device.

15. The system of claim 12, wherein the call scheduling module is executable to store the call-back call in a call-back event queue, and wherein the call-back call is a mutually available time for a user of the calling communications device and a user of the receiving communications device.
